(19) United States
(12) Patent Application Publication
(10) Pub. No.: US 2007/0179967 A1
(43) Pub. Date: Aug. 2, 2007

(54) Intuitive and Dynamic File Retrieval Method and User Interface System

(76) Inventor: Xiaoge Gregory Zhang, Toronto, ON (CA)

Correspondence Address: Xiaoge Gregory Zhang, 3 Weatherell Street, Toronto, ON, M6S 1S6, US

(21) Appl. No.: 11/562,841

(22) Filed: Nov. 22, 2006

Related U.S. Application Data
(60) Provisional application No. 60/738,663, filed on Nov. 22, 2005.

(51) Int. Cl. G06F 7/00

(52) U.S. Cl. 707/102

(57) ABSTRACT

A system and method for managing and retrieving computer files comprising a user interface system that dynamically coordinates and displays files by intuitive cues supplied by a user. The user interface system further comprises a database for storing file attributes namely, subject, keywords, information related to time, location in file directory system, file size, file type, indexing data, textual data and graphic data. It thus reduces a user's reliance on their memory for a specific filename by effectively leveraging a user's intimate knowledge about its possible drive or folder location, its file age, its content, and its subject matter, by making these cues constantly available and dynamically coordinated for users.

### FIELD OF THE INVENTION

This invention relates to computer, computer products, and methods for computer file organization and management. This invention relates more particularly to systems, computer products and methods for providing file organization and management user interfaces.

### BACKGROUND OF THE INVENTION

The use of computers in society has rapidly expanded. The amount and type of data that is accessed on any given computer in order to perform routine tasks has also expanded To this end, an efficient and user-friendly system for saving and retrieving information becomes increasingly important in the effective operation of a personal computer.

Currently, the data routinely manipulated using a computer such as a personal computer is stored in a variety of different computer files such as word processing documents, electronic mails, image files, graphs, tables etc., all of which can be in a variety of different file formats.

Numerous prior art inventions are known for organizing and managing such files. Generally, such files are organized in a directory file system of the well known “DIRECTORY TREE” structure. In this type of directory structure, a file is identified by a file name that comprises a string of letters and numbers. This file name is given at the time of the creation of the file by a User. The directory system is associated with a physical storage device (e.g hard disc) so as to provide means for accessing and retrieving such files using such file names from particular directories, sub-directories, sub-sub-directories, etc.

In such prior art directory systems, the multiplicity of files stored in association with such systems often requires a utility that permits a User to search for a particular file associated with such directory system.

In prior art solutions, there are generally two ways to retrieve a file in current PC applications. First, by use of the “OPEN” function commonly associated with computer applications, Secondly, by using a “SEARCH” or “FIND” utility associated with an operating system or software applications. All of the above functions and utilities, including their operation, are well known.

Particularly having regard to the “OPEN” and prior art solutions, the full file name of a particular file (including drive, folder name, sub-folder, and file name defined by user), which defines its location within the given directory/folder structure, is the principal means of locating and then accessing/retrieving the particular file.

Having regard to prior art “SEARCH” OR “FIND” utilities, a particular file location is found by entering search parameters such as words comprising file names, or text from the particular file being searched according to specified parameters such as type of files, file locations, and creation or access time. The search produces a list of folders and files. The file in question may be found upon further examination of the folders and files displayed, and perhaps further redefining the parameters. More recently, the technology for searching on the Internet has been also applied in the PC environment to help people better retrieving documents and information. Some searching tools are very fast but are not really a comprehensive retrieval method. Searching is only one of the many possible ways for information retrieval.

There are numerous disadvantages to the prior art solutions described above. These disadvantages can be generally summarized by stating that such prior art solutions do not make an efficient use of a human being's cognitive and memory capacity and do not address the differences in the manner in which individual users store information to memory and retrieve information from memory. These disadvantages result in loss of time, lesser efficiency and the expense of an inordinate amount of effort, brain capacity and memory in storing and retrieving information.

One of the primary disadvantages of the prior art solutions is that, from a perspective of providing a computer file management user interface that bears the attributes of human cognitive reasoning and memory/recollection, the requisite elements of a “natural” computer file management user interface are not provided in a single interface, in which such elements co-operate. By “natural”, in this disclosure, what is meant is consistent with the attributes of human cognitive reasoning and memory/recollection. In particular, as is well known, the brain retrieves information in accordance with multiple information associations that are “run” in many cases contemporaneously. Which particular multiple association will result in the most rapid retrieval of a particular piece of information (e.g. a computer file location) is not only difficult to predict from user to user but also, in the case of particular user from piece of information to piece of information, or for the same piece of information from instance to instance.

By way of further illustration, some individuals store and retrieve information according to rigid rules, and with great discipline. Other individuals, however, tend to store and retrieve information more “freely”, i.e with greater variance of multiple information associations,

For example, regarding the prior art “SEARCH” or “FIND” utilities, this feature is detached from the directory system accessible through the “OPEN” utility provided in most applications. This makes it difficult to effectively utilize the features of these different tools, as is required by a particular user to retrieve a particular computer file.

Similarly, the “FIND” or “SEARCH” function does not provide the structure of the directory. Furthermore, these functions are detached from the simple and useful function of accessing files based on chronology of creation/access/modification, based on specified time period. Such separation of the different ways of identifying, searching and locating a file greatly limits the effectiveness of file retrieval by these functions.

Thus, there is a great need for a system, computer product, and method for computer file management that is flexible from user to user, efficient and easy to use.

### SUMMARY OF THE INVENTION

This is a computer file management system and a information retrieval method comprising a software program, a database, a search engine and a unified and dynamic file management user interface for organizing and retrieving at least one of the plurality of computer files stored in the storage facilities in a computer associated with the database and the directory system in the computer operation system by means of a plurality of facilities dynamically.

This novel information retrieval method will help PC users to efficiently retrieve information in their PC environment through a dynamically coordinated methods and intuitively utilizing the cues most pertinent to the user. The system allows PC users to find files faster by reducing reliance on their memory and by effectively leveraging users' intimate knowledge about his/her own files, The consideration for strategies and design of the user interface is from users' prospective; the inventor of this system is a practicing materials scientist and had no formal IT training. The system acknowledges the fact that people associate things largely by where about (Directory), when occurred (time) and subject matter (keywords) and makes these cues constantly available and dynamically coordinated for users.

This method is capable of extensive user customization, while providing continuing access to the full range of utilities accessible by means of the unified interface that is optimized for the human visual cognitive preference and capability in addition, the various utilities provided by means of the unified interface co-operate in a manner that permits efficient file management by a variety of users. This method is a major improvement over the previously existing methods used in common software applications and search tools as illustrated in FIG. 1. Most software applications have used two methods for file retrieval: the file directory and a search engine. The two methods are not coordinated nor are available in the same careen to the user. Plus, the cues in the search engine are not dynamically coordinated; a new search has to be done each time one query is changed On the other hand, search tools are generally based only on its search engine, which is very effective in the Internet but is not so in a PC environment. For most users, search is the first choice for finding information in the web but is the last resort within a PC environment.

Past and current commercial products focus on search engines, which is only one of many retrieval strategies PC users may use. Technically, search is a selection process based on predetermined criteria. This invention, on the other hand, is principally based on the process of elimination which is inherently more accurate. Also, it must be much quicker when the methods for elimination are made dynamic and intuitive to the users.

Another advantage of this method is its flexible nature towards different users and at different situations. By making different ways dynamically available at the same time, the users can proceed with the one best suited in a given situation People recall things differently, some mainly by time, some by where about, some by subject mater. As well, the same person may recall things differently at different situations. Providing just the directory system or search engine forces a particular method on people without considering individual's situation, preference and ability in information retrieval. This invention is a major improvement towards addressing situation specific and individual specific needs in information retrieval and best utilizing individual's knowledge, intuition and creativity in retrieving their own information.

### BRIEF DESCRIPTION OF THE DRAWINGS

A detailed description of the preferred embodiment(s) is (are) provided herein below by way of example only and with reference to the following drawings, in which:

FIG. 1 compares the method disclosed in the present invention with two common current methods.

FIG. 2 is a system resource flowchart illustrating the resources of the system of the present invention.

FIG. 3 is a program resources flowchart illustrating the resources of the computer product of the present invention.

FIG. 4 shows the basic operational features and functions on the “SAVE SCREEN” provided by the present invention.

FIG. 5 shows the features for helping user to choose name of the file in the “SAVE SCREEN”

FIG. 6 illustrates the basic operational features and functions on the “RETRIEVE SCREEN” provided by the present invention.

FIG. 7 illustrates the options that can be possibly provided in “File type”, “File size” and “Key words” facilities.

FIG. 8 illustrates the options that can be possibly provided in “File listing” facility.

FIG. 9 illustrates a design of the box for making the default settings of the file management system.

FIG. 10 illustrates the possibility with an enlarged pane of file listing by removing the pane for the “Time” utility.

FIG. 11 illustrates the possibility with further enlarged pane of file listing by removing the pane for both “Time” and “Directory” utilities.

FIG. 12 illustrates a particular means provided by the present invention for displaying the content of a particular file, namely of thumb nail presentation of an image.

FIG. 13 illustrates another example of means provided by the present invention for displaying the content of a particular file, namely of display of the first two sentences of a file.

FIG. 14 illustrates the operation of the “Key word” utility in combination with the “Directory” and “Time” utilities. The file list in this example is according to Index mode which is based on the alphabetic order of the file titles.

FIG. 15 illustrates the operation of the “Time” pane with a setting for a particular “YEAR” and the “MONTHS” within that year.

FIG. 16 illustrates the operation of the “Time” pane with a setting for a particular day with “Last week”.

FIG. 17 illustrates the operation of the “Time” pane with a setting for a particular “Day” within a particular month of a year.

FIG. 18 illustrates the operation based on “Key words” matching with setting at “Name & content” and listing the mode “Key word relevance”.

FIG. 19 illustrates the operation of the “Directory” pane with a folder is opened to show the all the folders and files in the folder.

FIG. 20 illustrates screen for the facility for reorganization of the existing directory

FIG. 21 illustrates a box for choosing the names of sub folders

FIG. 22 illustrates the facility for filing all the old files in an old file directory according to a specified time.

FIG. 23 illustrates the screen for retrieving emails

FIG. 24 illustrates a modification of the screen for email retrieval in FIG. 23 with a streamline operation of keyword scope selection and activation.

FIG. 25 illustrates a modification of the screen for file retrieval (FIG. 7) with a streamline operation of keyword scope selection and activation.

FIG. 26 illustrates the operation of the present invention in a network environment.

In the drawings, preferred embodiments of the invention are illustrated by way of example. It is to be expressly understood that the description and drawings are only for the purpose of illustration and as an aid to understanding, and are not intended as a definition of the limits of the invention. In particular, the unified file management interface disclosed herein is not limited to the particular screen layouts, organizations or structures, which are provided by way of reference only.

### DETAILED DESCRIPTION OF THE PREFERRED EMBODIMENT

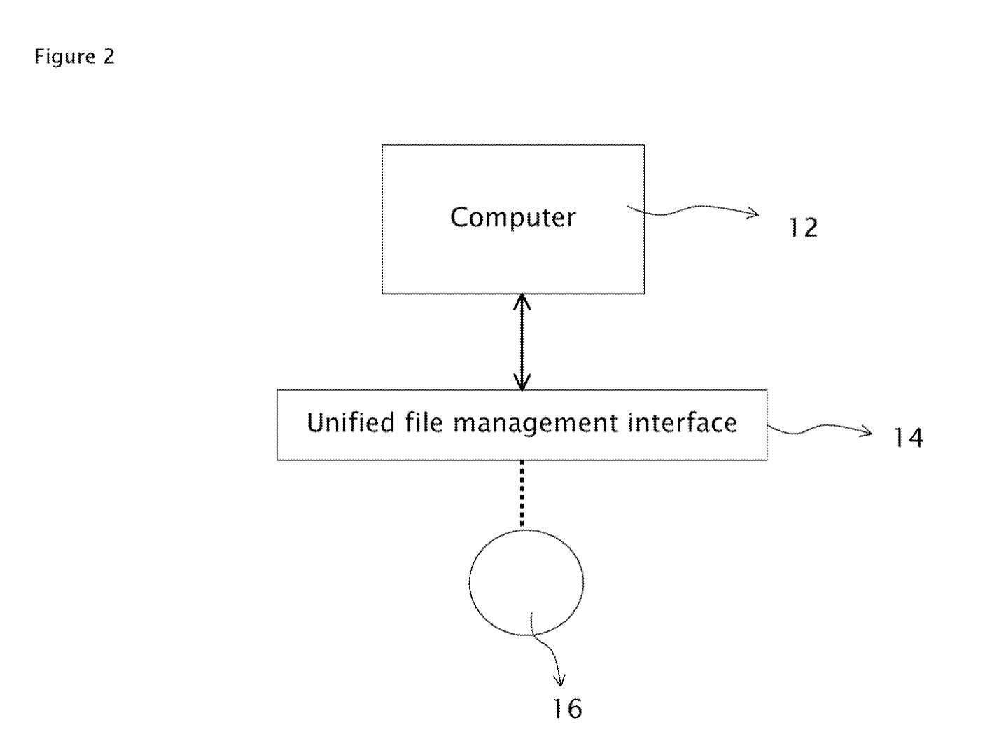

The system of the present invention is best understood by reference to FIG. 2. FIG. 2 illustrates the system of the present invention which comprises the computer product of the present invention, installed on a computer 12. It should be understood that the computer product of the present invention may be installed on any type of computer whether a system computer, network computer, personal computer, portable computer or the like.

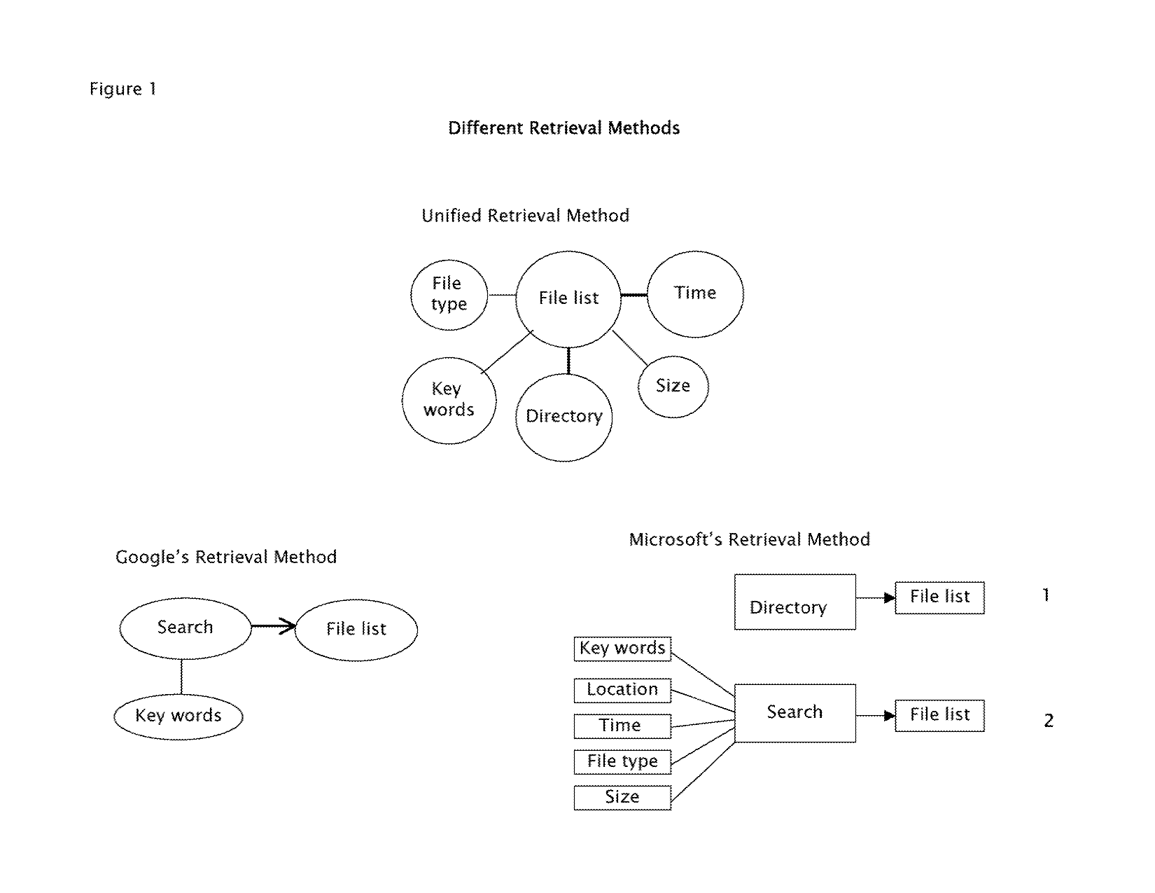

The computer product of the present invention is best understood by reference to FIG. 2. The preferred embodiment of the present invention comprises a computer application that is programmed in a manner well known to those skilled in the art. This computer program provides the unified file management interface 14 described herein. The purpose of the unified file management interface 14 is to enable a User 16 (as shown in FIG. 1) to organize and retrieve computer files.

Preferably, unified and dynamic file management interface 14 is programmed so as to run on the operating system of computer 12. The computer product of the present invention is therefore installed on computer 12. Suitable interfaces can be programmed by a person skilled in the art between the unified file management interface 14 of the present invention and other computer programs associated with computer 12 such as word processing programs, graphic design programs and the like. In this way, the unified file management interface 14 can be used as a central interface for file management.

Alternatively, the unified file management interface 14 of the present invention can be associated with one or more of such computer programs, so as to present means for providing file management associated with such computer programs in particular. For example, the unified file management interface 14 of the present invention would in this way replace or complement the “OPEN” or equivalent utility generally associated with or included in computer programs where files are created/accessed/modified.

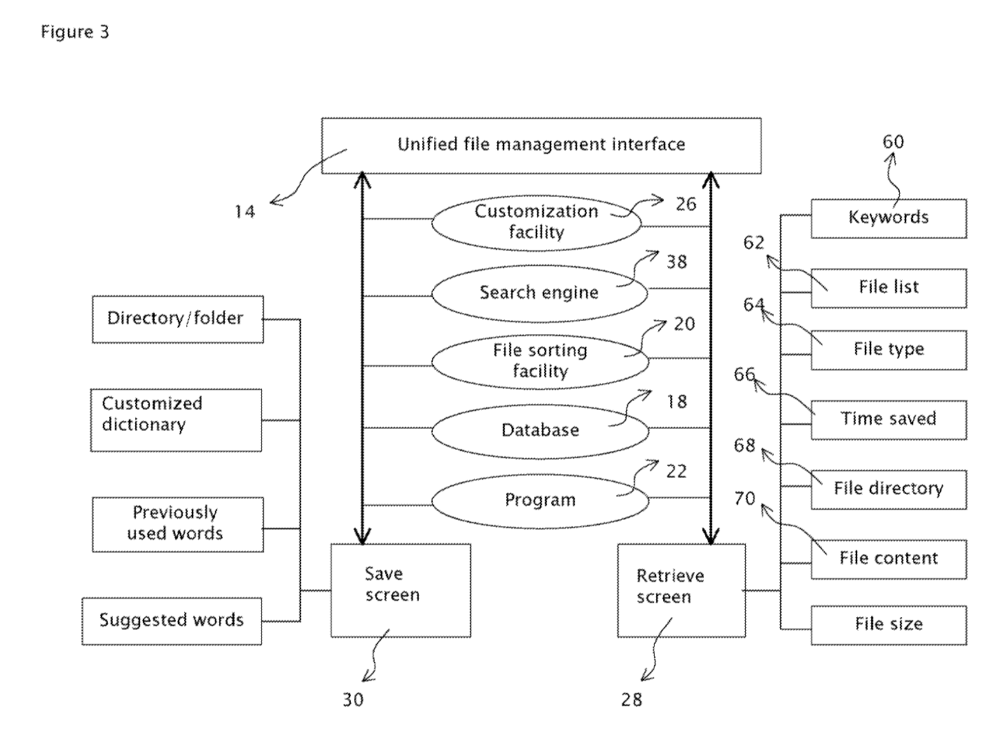

As illustrated in FIG. 3, the present invention comprises a File Sorting Facility 20 which co-operates with Database 18. The purpose of File Sorting Facility 20 is to determine, in accordance with default settings, which of the computer files associated with database 18 are likely to be of interest to User 16 on an ordinary basis. These computer files are essentially user-generated or user-modified files as opposed to system files. All the attributes that is possibly usable for helping User 16 to retrieve files, such as name, thumbnail image, date and time, size etc, are organized in Database 18 such that each and every file is properly indexed for variety types of operations and manipulations needed for quick and accurate file retrieval. Criteria and operation for differentiating between these categories of files are provided in a manner that is well known and are determined by Program 22 that is associated with the computer product of the present invention. Said criteria take the form of File Selection Default Settings (predetermined under Tools on the Head Bar) provided to File Sorting Facility 20 As is more fully described below, the present invention provides means for displaying in the “DIRECTORY TREE” only user-generated, user-modified files or actual files downloaded from the Internet or received as electronic mail, or attached to electronic mail (“User Interest Files”) when User 16 is searching for a particular file by means of the invention described herein. This saves the time that might be spent scrolling through or perhaps even accessing system files or other files that are not likely to be of interest to User 16. However, system files can also be retrieved using the present invention, by modification of File Selection Default Settings, in a manner that is well known.

It should be understood that User Interest Files may be of a wide variety of file formats, generated by a wide variety of computer programs.

It is also understood that database, file sorting and search engine are well known to the people who have stills in the arts and no further explanation will be provided for what they are and how they work.

The preferred embodiment of the present invention also comprises Customization Facility 26 which presents means for customizing the File Selection Default Settings of File Sorting Facility 20 to provide alternative settings designed for particular file search strategies that reflect the type of work done by User 16 on computer 12. To provide means for selecting such alternate settings, Customization Facility 26 provides a series of tools such as scroll down menus (such as “Tools” on the head bar) and the like to provide the elements of such alternate settings, in a manner that is well known.

In addition, it should be understood that Customization Facility 26 provides means for customizing the unified and dynamic file management interface 14, including which functions (particularized below) are accessible via a particular user's customized interface, and how these functions are represented or accessed therein, in a manner that is well known.

The unified and dynamic file management interface 14 comprises two principal screens, namely a “RETRIEVE SCREEN” 28 and “SAVE SCREEN” 30, as shown in FIG. 3. As explained below, “RETRIEVE SCREEN” 28 and “SAVE SCREEN” 30 comprise interfaces provided co-operatively by a series of software facilities of the present invention described below. Seen in another light, “RETRIEVE SCREEN” 28 presents a retrieve facility, whereas “SAVE SCREEN” 30 presents a save facility.

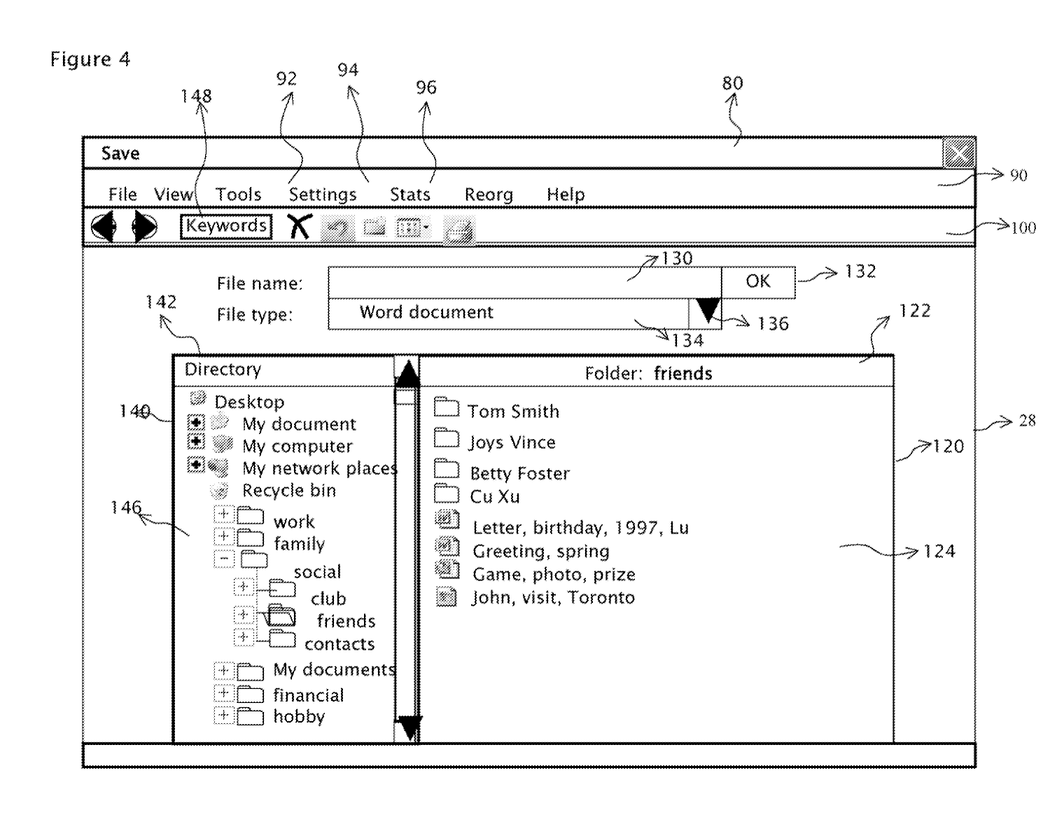

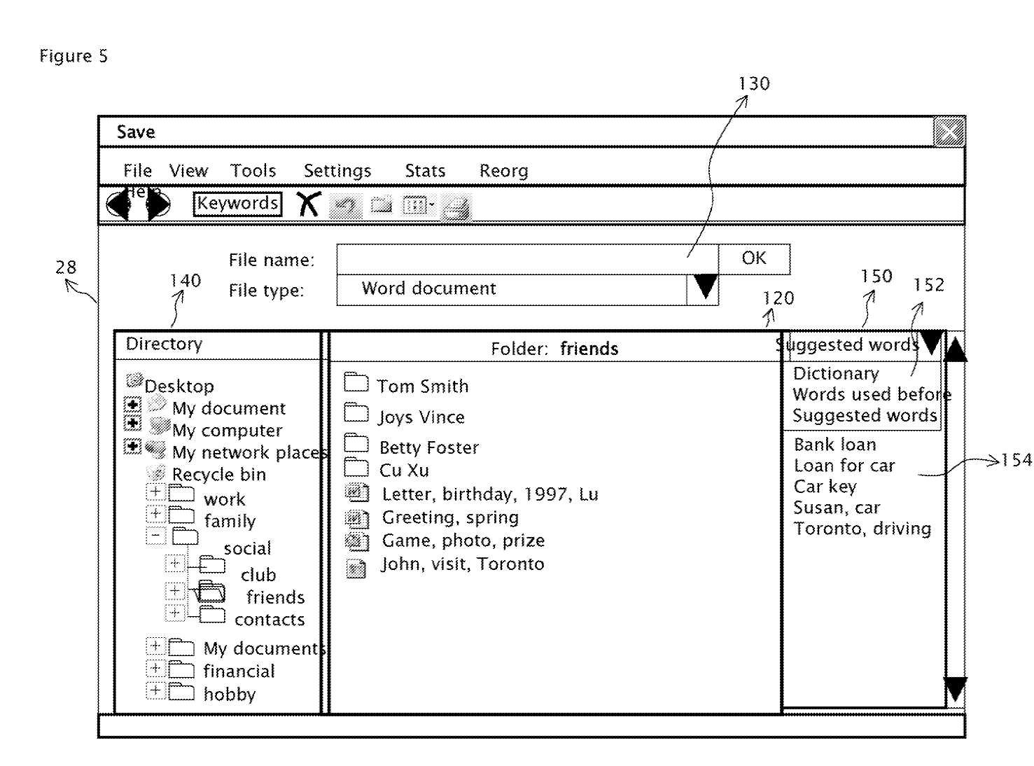

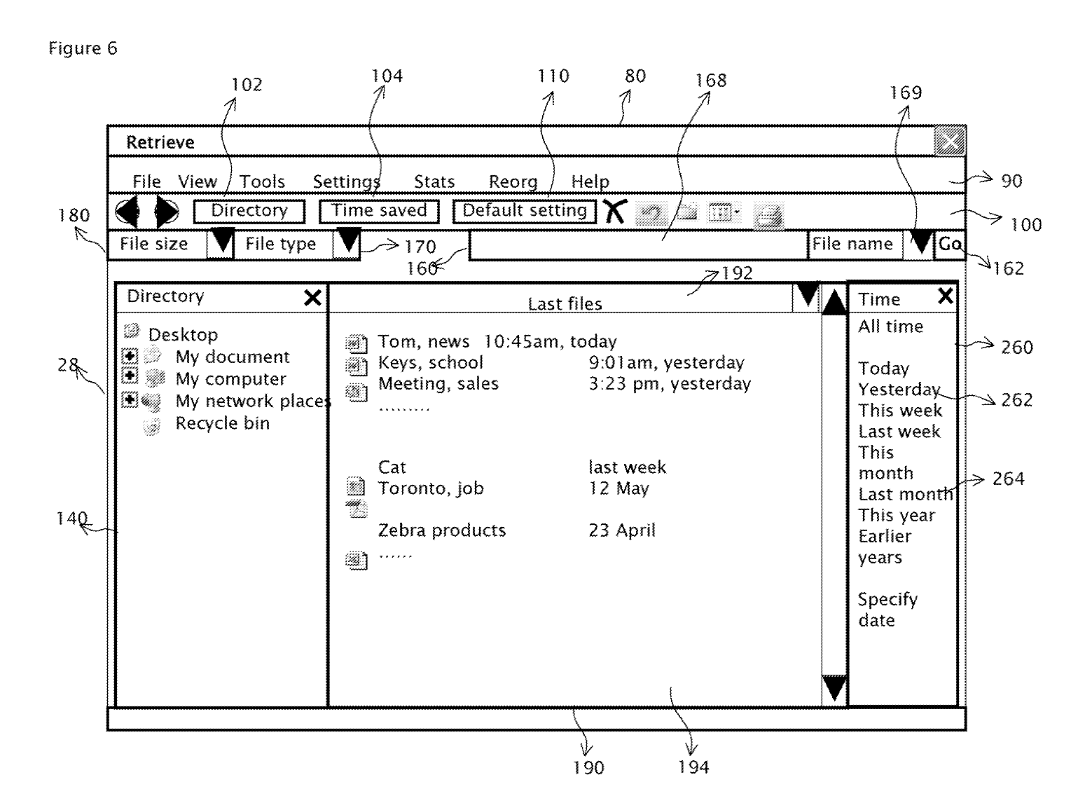

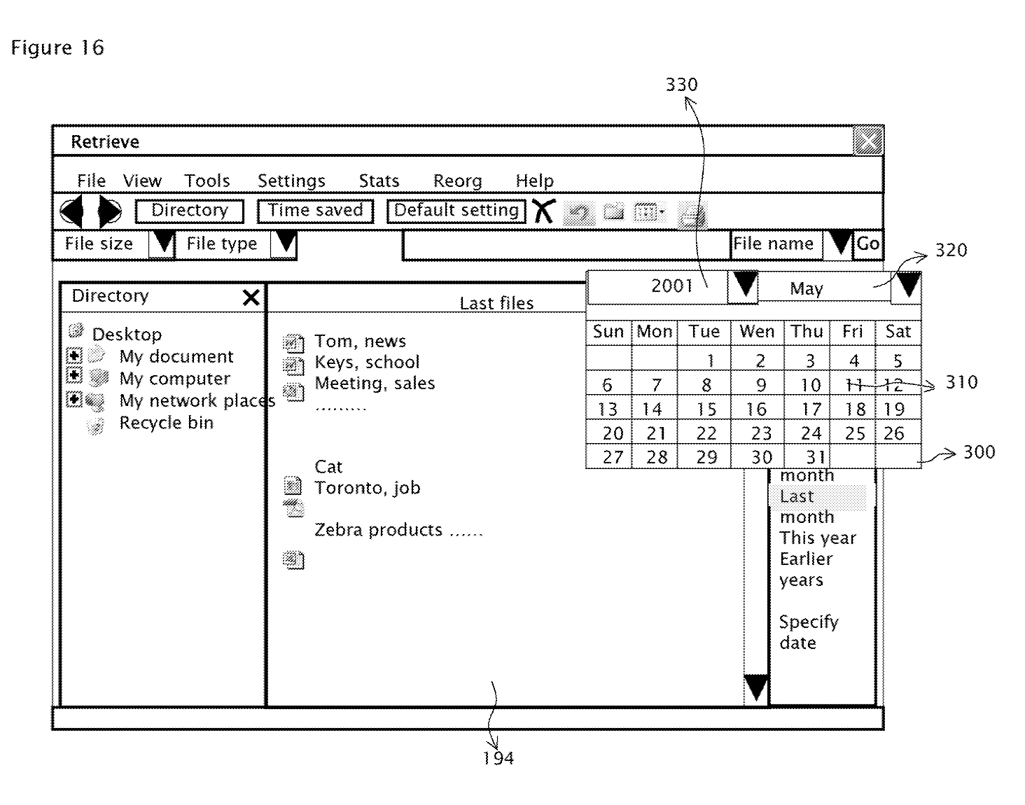

FIGS. 4 and 5 illustrates particular aspects and applications in operation of the “SAVE SCREEN” 30 of the present invention. FIGS. 6-19 illustrates particular aspects and applications in operation of the “RETRIEVE SCREEN” 28 of the present invention.

The “SAVE SCREEN” 30 of the present invention is analogous to the “SAVE” or “SAVE AS” utility commonly associated with computer programs that create/access/modify computer files. The “RETRIEVE SCREEN” 28) on the other hand, is analogous to the “OPEN”, “FIND” in current software applications.

A file can be saved with a file name consisting of a single string of letters and numbers, which is identical to the currently used in various software applications. To assist in the selection of appropriate keywords, several lists of words are provided on the “Save” screen 30, as illustrated in FIG. 5. This is because day to day operation of computer 12 by User 16 will likely result in the creation/access/modification of similar computer files from time to time. Therefore similar keywords may be appropriate to designate such computer files. Therefore, rather than attempt to recall past aptly chosen keywords, past keywords selected are presented by such lists to User 16. An additional advantage of such lists, is that when User 16 begins to type in a particular keyword in the appropriate “File Name” box 130 shown in FIG. 5, such lists will provide the basis for dynamically selecting likely matches for the letters typed at any given time from such lists from time to time. This feature is provided in a manner that is well known.

Another aspect of the present invention is the unified approach to computer file retrieval. By “unified” what is meant is that the present invention unifies within a single interface the various utilities that are dynamically co-ordinated for retrieving a computer file that are likely to complement the particular word-image-logic association of the particular user in regard to a particular computer file. What is also meant by “unified” is that such various utilities are “unified” in the s sense of “integrated”. By “integrated” what is meant is that such various utilities are presented in an interface in a way that encourages the use of such utilities in various co-operative combinations. In this way, the preferred embodiment of the present invention permits a particular user to utilize said utilities in a manner that is as consistent as possible with the particular word-image-logic association that is elicited by the particular user's recollection of the particular computer files.

“Save Screen”

The “SAVE SCREEN” 30 of the present invention provides means for accessing the Save Facility (not shown) of the present invention, The functions of the Save Facility are best illustrated in FIG. 4 and FIG. 5, which illustrate that “SAVE SCREEN” 30 contains a box 130 for entering keywords as file name; a directory pane 140 for selecting the storage device or the drive or folder; a pull-down menu 134 to select type of file; a window 120 for displaying files; and a list of words 154 in the pane of “Suggested Words” 150 to help for keyword selection, as described above. All of the above features are provided in a manner that is well known.

Also, it should be understood that the list of key words can be expanded to included the contents of a dictionary, for example, in a manner that is also well known.

The unified and dynamic file management interface 14 presents a “Menu Bar” 90 and a “TOOL BAR” 100 in a manner that is well known, to access its various functions, including Customization Facility 26. The tools displayed on the “Tool Bar can be set according to user's selection in the menus on the “Menu Bar”. The rules for listing the keywords, for example, can be selected in the “Settings” function on the “Menu BAR”, in co-operation with Customization Facility 26, in a manner that is also well known. The tool bar to can provide variety of features including the various file management features and functions that are customary, such as “copy”, “delete”, “print”, “setting” features etc.

In operation, to save a file, User 16 enters a certain number of words to name the file and the computer will automatically save the file by the words and all the other attributes associated with the file in a database, as described above. More specifically, by clicking the “SAVE” icon, the system of the present invention is prompted with the screen shown by FIG. 4 for User 16 to enter keywords. The keywords may or may not be provided with a hierarchical structure, depending on the user's preference as provided in the “Settings” associated with the unified and dynamic file management user interface of the present invention.

In operation, where a computer file in database 18 has already been previously associated with the particular keywords selected, the keywords of the file and the route in the directory are displayed by the unified and dynamic file management user interface of the present invention, and also a window is prompted asking whether to replace the existing file or to modify the keywords of the file to be saved.

Again, in operation, to help in selection of keywords, by clicking the “Keywords” button 148 on the “Tool Bar” 100 or making a choice in the “Tools” several types of word list 152 are provided on the “SAVE” screen as shown in FIG. 5. The user is provided with a list of the words so which are most pertinent to particular computer file by means of a Search Engine 38 associated with the computer product of the present invention for searching the computer file based on predetermined criteria so as to offer potential keywords to User 16 based on, for example, the content, heading, recipient, sender, first five lines etc. These criteria can also be modified by means of the “SETTINGS” provided by the Menu Bar, in co-operation with Customization Facility 26.

The list of words selected automatically in this way may consist, again based on the “SETTINGS” provided (and which may be modified), of a predetermined number of nouns or verbs (or other words preferred by a user) deemed by computer 12 to be the most apt as key words based on the criteria referred to above. User 16 can simply click the desired words in the list in the box to enter them in the keywords box. The suggested words can also be optionally listed as suggested file names, which are a combination of two, three or more keywords and are selected by the system based on certain rules. This option and the number of words as well as selection rules can be specified by means of “SETTINGS” provided by operation of the Tool Bar, in co-operation with Customization Facility 26, in a manner that is well known. Also, the words, which were used in the past, can be, as options, listed chronologically or alphabetically. In addition, a dictionary of words may be provided, as described above. Further in addition, the contents of such dictionary can also be tailored according to the needs of the user.

For easier subsequent computer file retrieval, a predetermined amount of content information from the particular computer file is also saved as a part of the file attributes. For example, the first 30 words or the first three sentences or the title or the last 25 words of a text file, or the first three slides for a PowerPoint presentation file, or a skeleton image (an image with the minimal bits of data) of an image file etc, are stored as a part of the file attributes. This content information is saved along with other file attributes in database 18.

“RETRIEVE SCREEN”

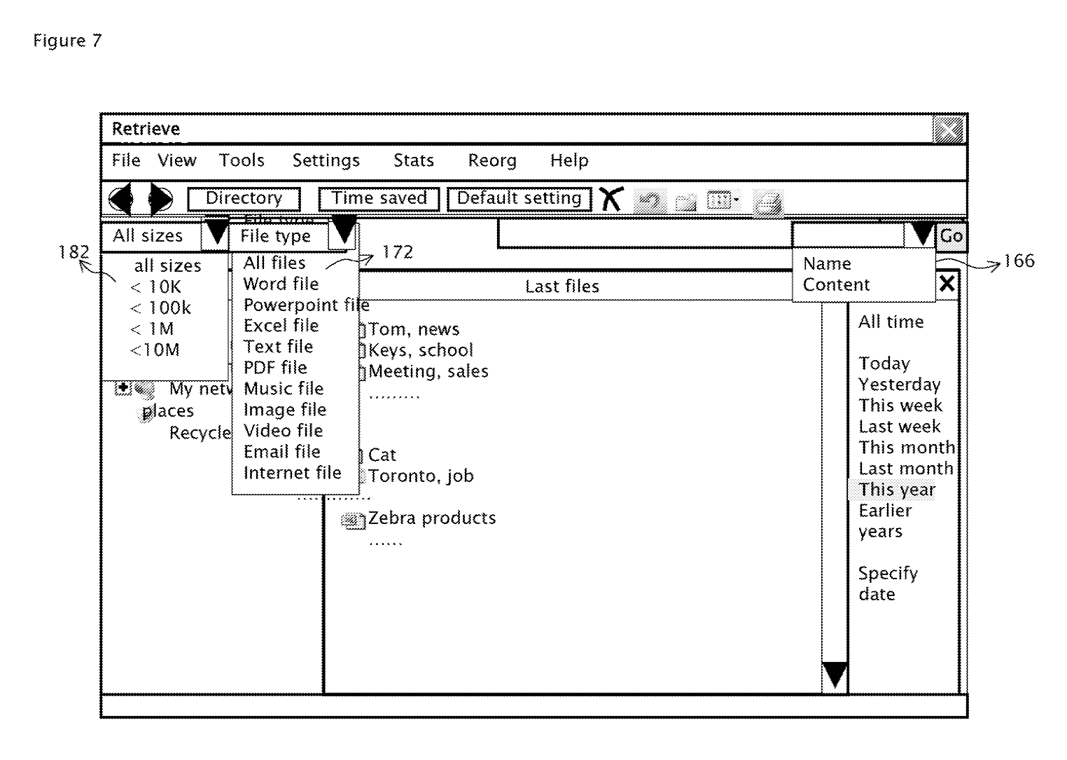

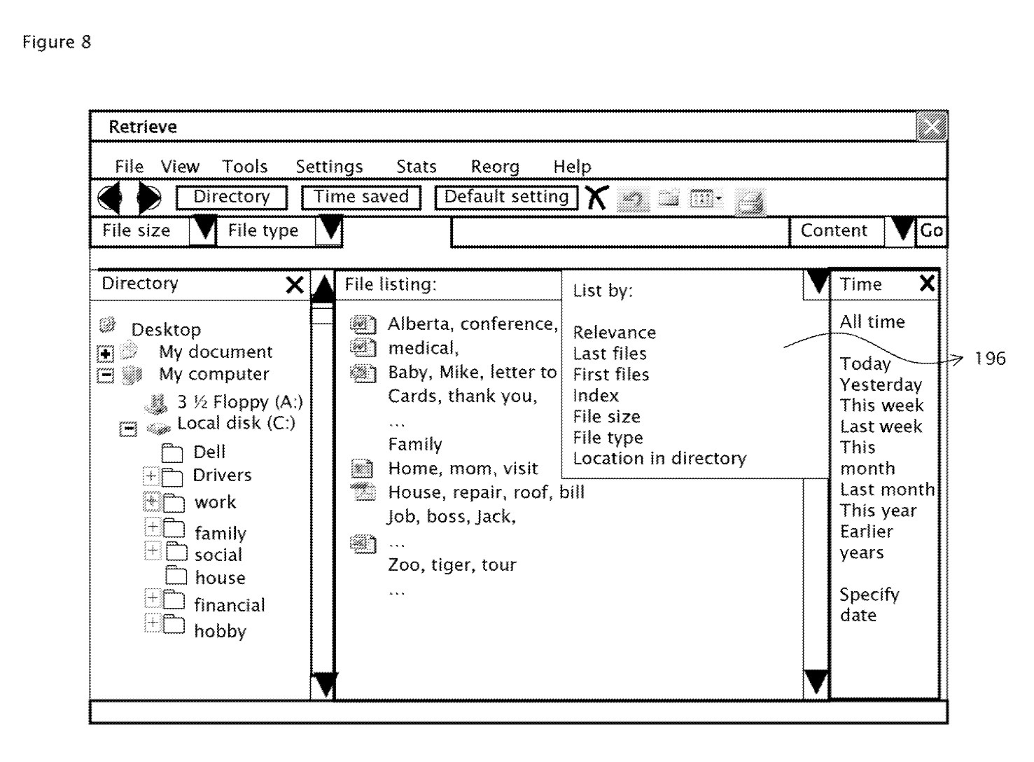

The “RETRIEVE SCREEN” 28 of the present invention presents an interface for User 16 to retrieve files using. The “RETRIEVE SCREEN” is provided by means of a Retrieve Facility of the present invention. The functions of this Retrieve Facility are best illustrated by reference to FIG. 6 FIG. 6 shows that to retrieve a file, upon clicking the “RETRIEVE” icon (or equivalent) a screen is prompted with multiple file retrieval methods. FIG. 6 in particular illustrates the operational features and functions on the “RETRIEVE SCREEN” 28 for file access by “Directory System” 140, “Keywords” 160, “Time Period” 260 for the saved files assisted by “order of file listing” 192, “File size” 180, and “File type” 170 specifics. The options in “File size”, “File Type”, “Order of file listing” as well as options for “key words” matching are illustrated in FIG. 7 and FIG. 8. The files that match the conditions specified by the retrieve facilities of “Directory system”, “keywords”, “Time period”, “File size” and “File type” are displayed in the “Display Pane” 194 in an order specified in “Order of File listing” 192. The specific condition for each of the facility can be selected from the pull down menus 182, 172, 166, and 196 for selection on file size, file type, scope of keyword match and type of file listing respectively These conditions listed in the pull down menus are provided as examples for illustration purpose and can be designed in variety of ways in actual application. Alteration of the condition in each facility will dynamically result in corresponding changes in the files listed in the file listing pane allowing the user to seamlessly alter, shrink or expand the list of files for most efficient file retrieval. In particular, the default setting for the “Retrieve Screen” 28 can be set and reset in the “Default setting” window 200 which is open and closed by click the “Default” button 110 on the “Tool Bar”

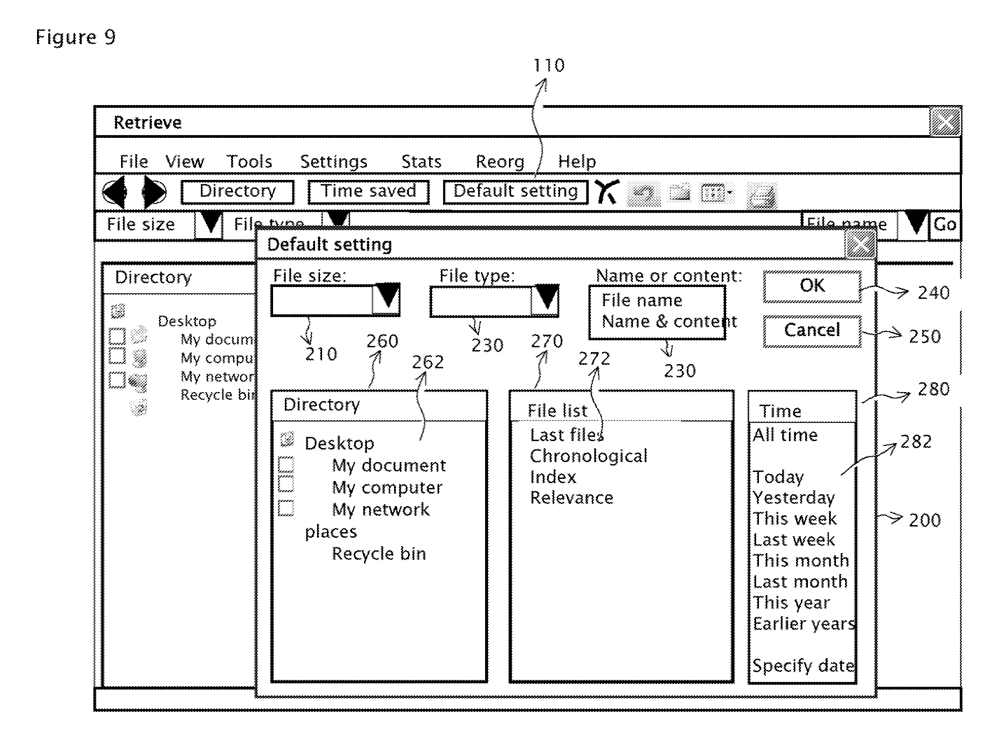

“RETRIEVE SCREEN” 28 is also associated with a Menu Bar (e.g. shown in FIG. 6) which in co-operation with Customization Facility 26 permits the unified and dynamic file management user interface to be customized, by dynamically varying which combinations of utilities are used in co-operation to retrieve a file within the interface of the present invention. This customization is provided in a manner that is well known. In particular, the default settings on the “RETRIEVE SCREEN” 28 can be specified and altered by the “Settings” on the head bar according to the preference of the user as for example illustrated in FIG. 9.

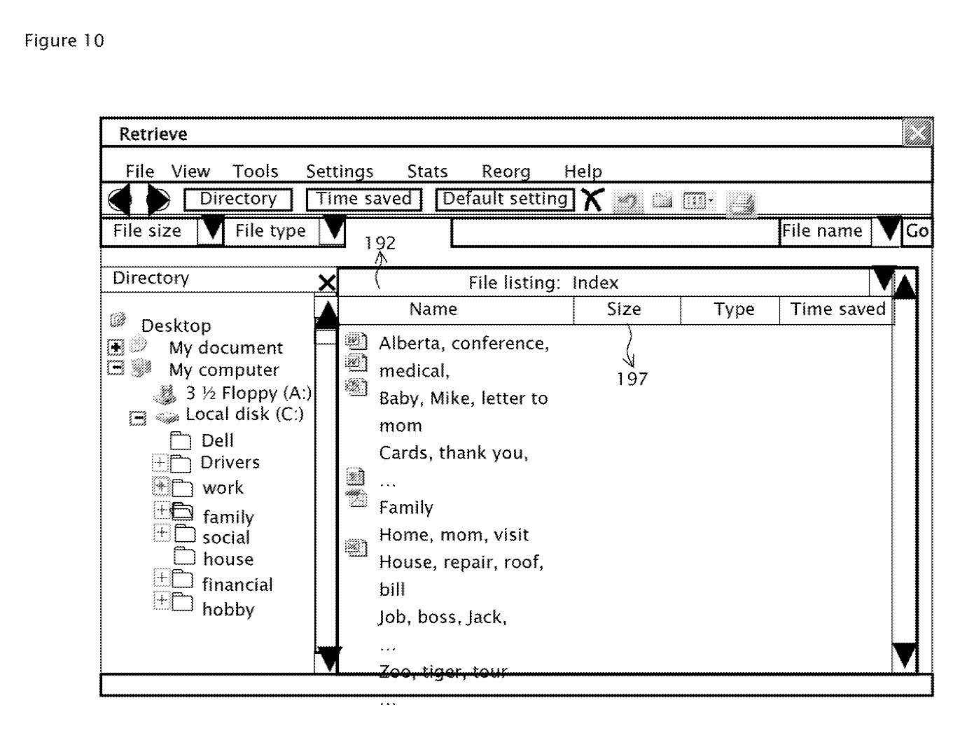

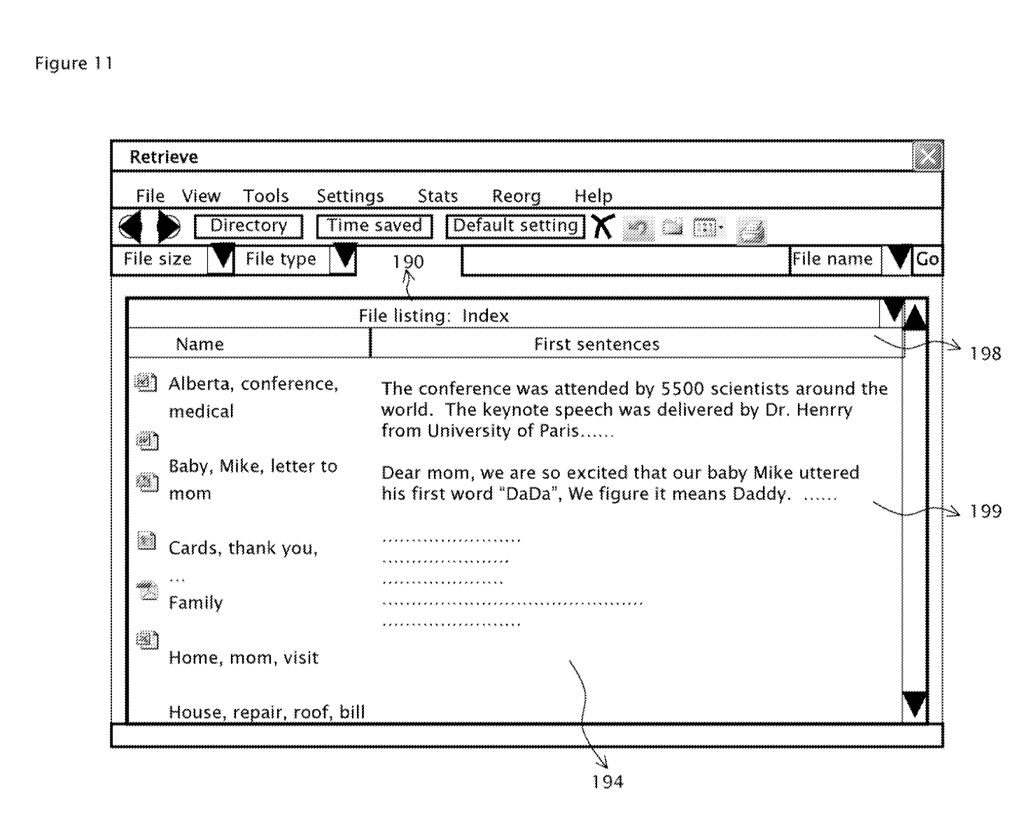

Using the interface shown in FIG. 6, User 16 can, depending on what is most convenient at the moment, quickly locate and access a file by using the directory system, by entering specific words, or by listing the files chronologically. The file listing pan only displays the ones that match with the specifications by keywords, time saved, type of file and size, as well as the domain in the directory system. In particular, the directory system 140 and the time saved 260 are two unique and most associable ways for people to locate files and information. These two utilities are provided with open pans on each side of the file listing pane 190 as shown in FIG. 6. The directory pan and time pan can be removed by clicking on the buttons on the tool bar making space for the file listing pan as shown in FIG. 10 and 11. In the file listing pan 190 there can be another bar 197 on top of the list to indicate file name, size, time modified in a way as that currently used in other common software. As a further way to help identify a file, the bar can also be altered to indicate the first or two or more sentences of the file as shown in FIG. 11.

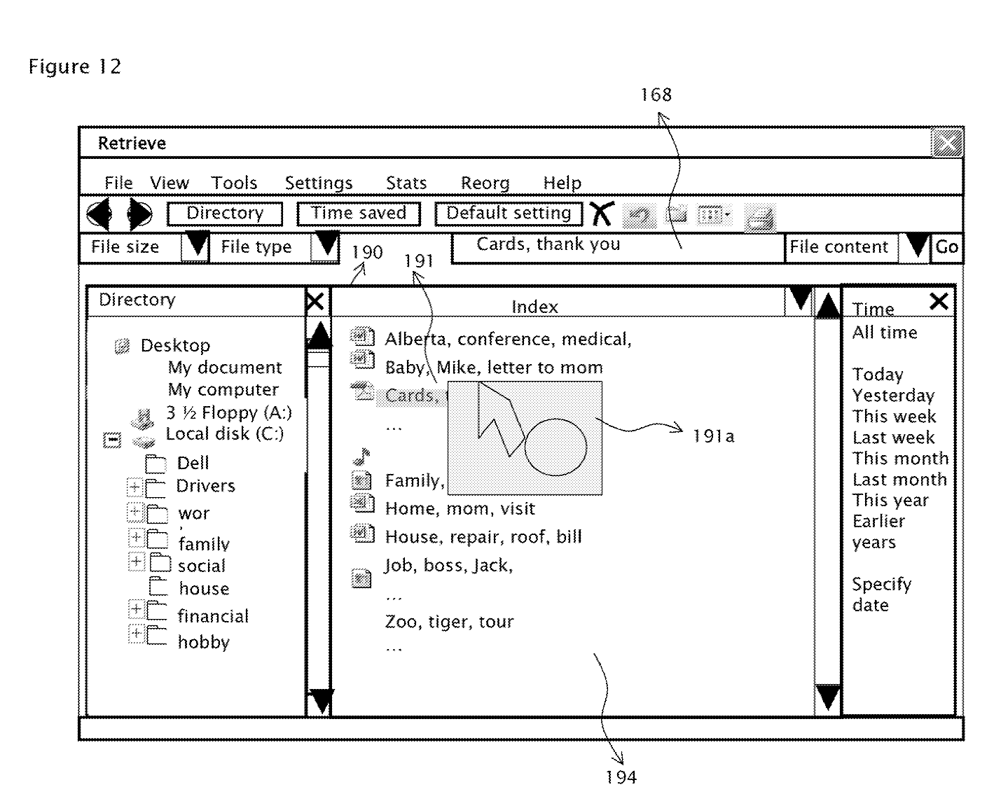

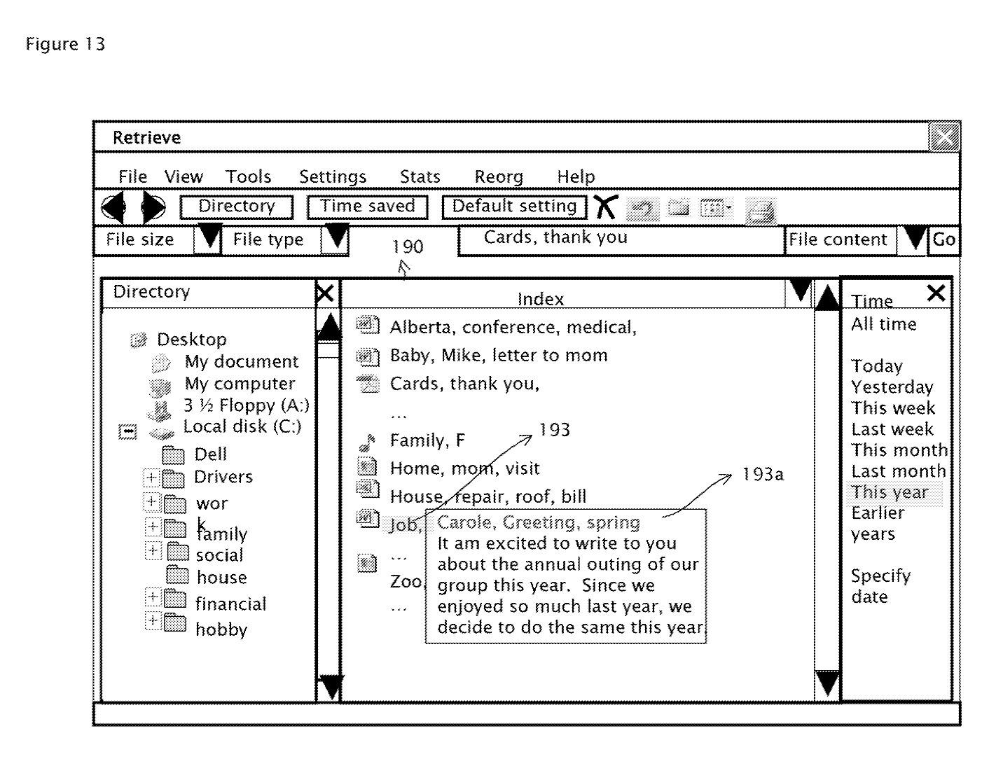

The content of the file can be examined by placing the cursor on the specific file name 191,193, which displays a certain amount of words, several sentences 193a, or a thumbnail image 191a, depending, as examples shown in FIGS. 12 and 13. The file properties such as file size or the time when the file was saved can be displayed by right-clicking on the file in question. If it is the correct file, a double click of the file name will open the file, and the retrieval process is complete.

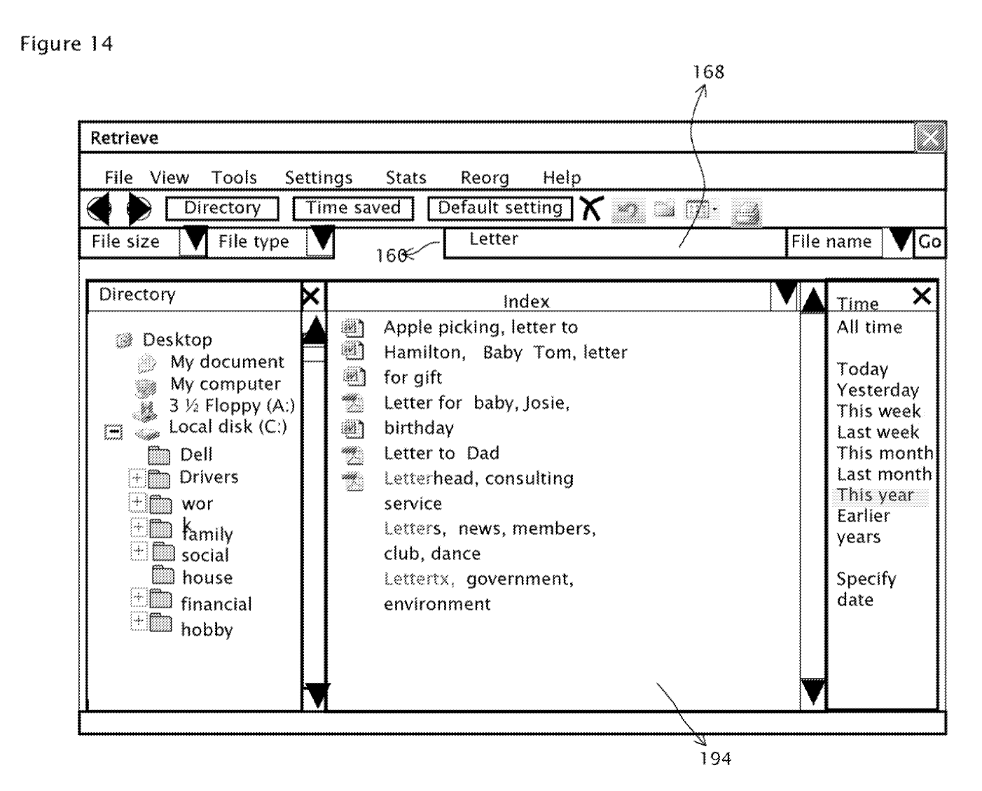

The User 16 can retrieve a file through the Keyword Facility 60 by entering certain words into the keywords input box 168. For example, if one entering the word “letter” and clicking “GO” 162, a screen appears listing the files, which contain the word “letter”. As shown in FIG. 14 the file list pan will list the files that are stored in the Local disk (C:) within this year shows and contain the word “letter” as a part of the file name. The list may change if one changes different setting in the File type 170, File size 180, Time saved 260, and drive or folder in the directory system 140. When it is used for content match, the search strategy can be designed in accordance with the frequency or the relative importance of the type of particular words, e.g. whether the particular word appears in the title, the first page or the last page etc. Such options regarding Keyword Facility 60 can also be provided in the Menu Bar, in co-operation with Customization Facility 26.

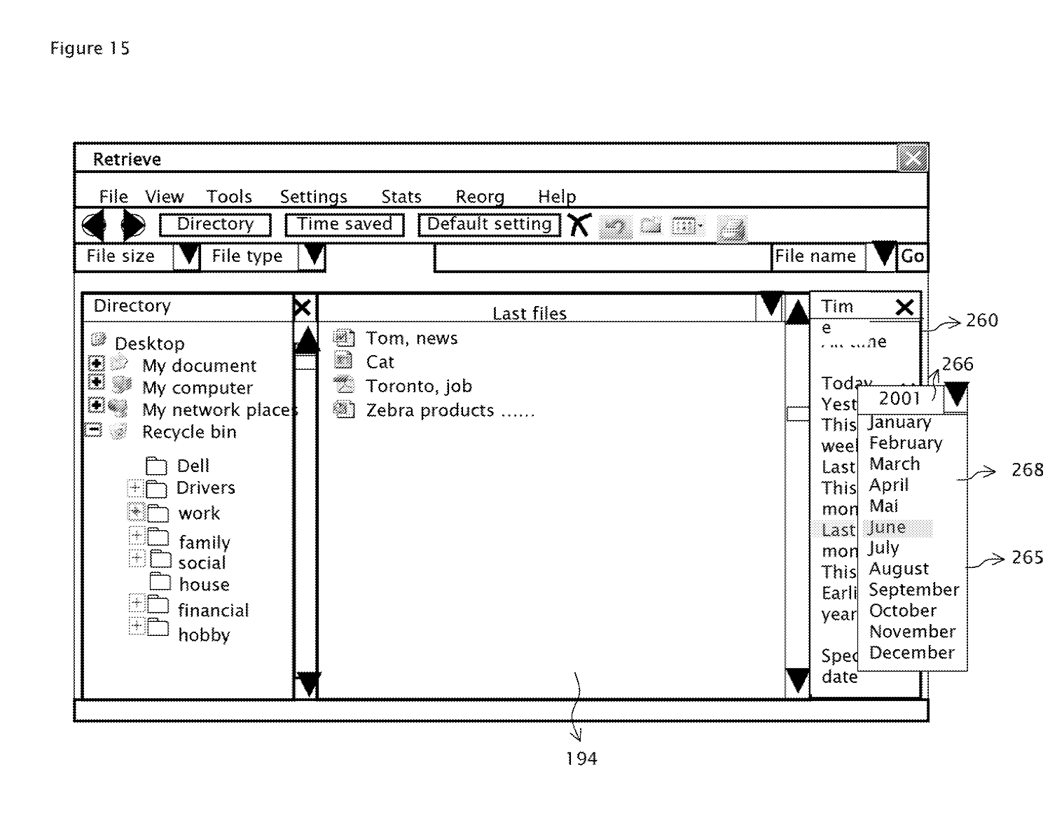

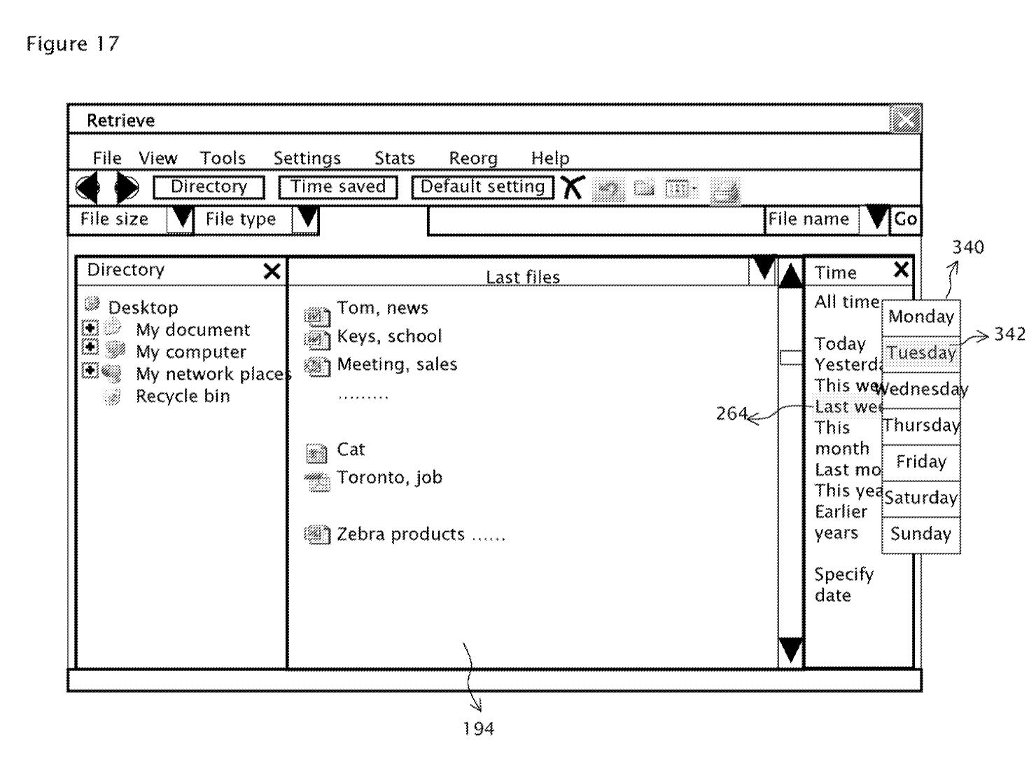

Time, as an important memory cue, can be further utilized for time-based file retrieval. By using the day of the week, or the week or the day in a month, or the month in a year, which is how people plan, execute and remember their activities in daily life, the number of files can be narrowed. This method can therefore be particularly effective for the User 16 to retrieve files that are strongly associated with time. By double clicking the time period in the Time pan, the files that had been worked within the specified time period are listed in an expanded window as shown in FIG. 15 to FIG. 17, depending on whether the time period is a week, a month or a year. For example, FIG. 17 shows the time modified file retrieval method by double clicking the selected time period in the time column, and in this case it is Last Week 264. The list of the files in the window can be further modified by the day of the week and/or by the folders in the directory system as well as by entering keywords.

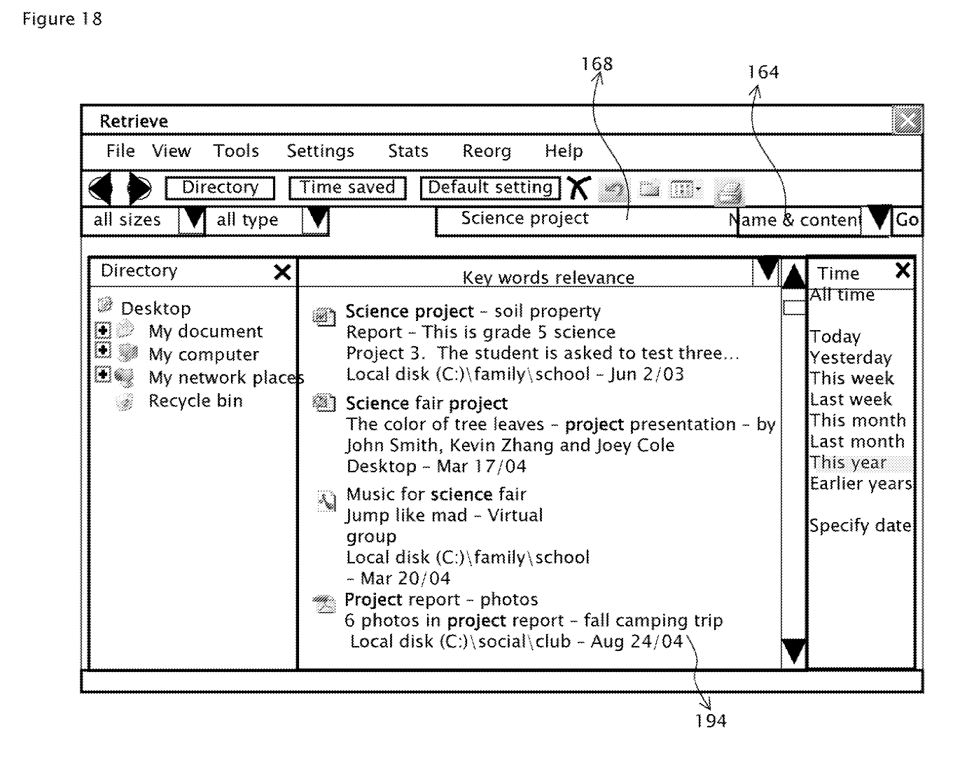

In certain situations, the User 16 may fail to remember and recognize any keywords associated with a particular file. This may be because time has elapsed, or the keywords have been provided by another user, for example, in a network environment. In such situations, key words can be used to match file content and thus to retrieve the needed files. By selecting Name & Content in the box 166 next to the “GO” button 162 as shown in FIG. 18, one can start typing words in the Keywords entry to match the files that contain those keywords in the domain that is defined by the setting. For example, FIG. 18 shows that fours files are listed in the File Listing pan with key word match for “Science project”. These file can be list in order of relevance for the content match as the default setting but can also be listed according to Index or Last files by making changes in the “Settings” on the tool bar. Also, unlike File name-only retrieval, it lists also the pertinent content of the file under the file name as well as the route in the directory system similar to those listed on the World Wide Web using a search engine.

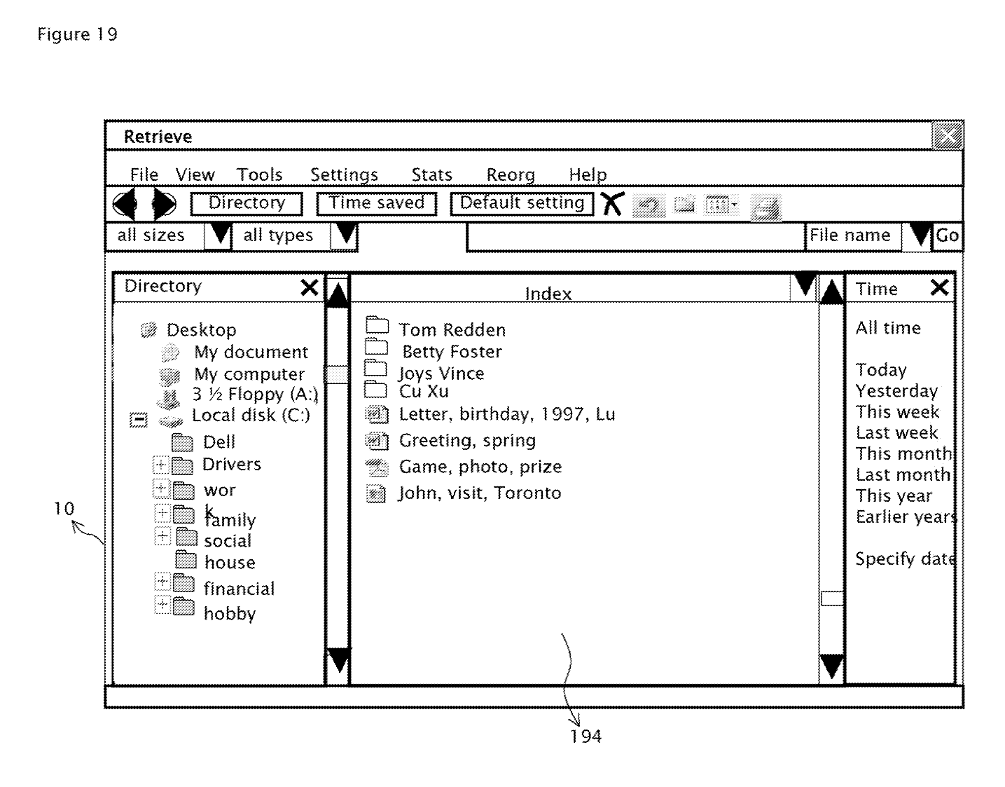

When a folder in the directory pan is clicked open as shown in FIG. 19, all folders and files that are contained in the folder are listed in the File listing pan 194. This allows the user to explore and organize the files and folders in the directory system similar to those tools commonly used.

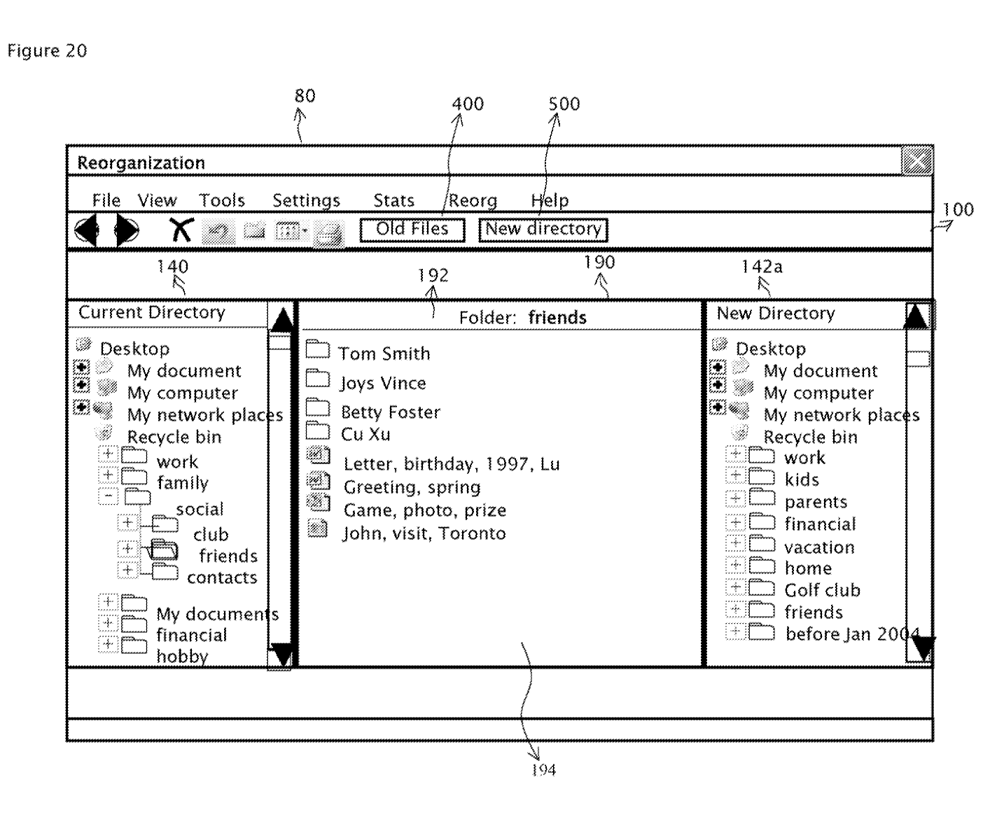

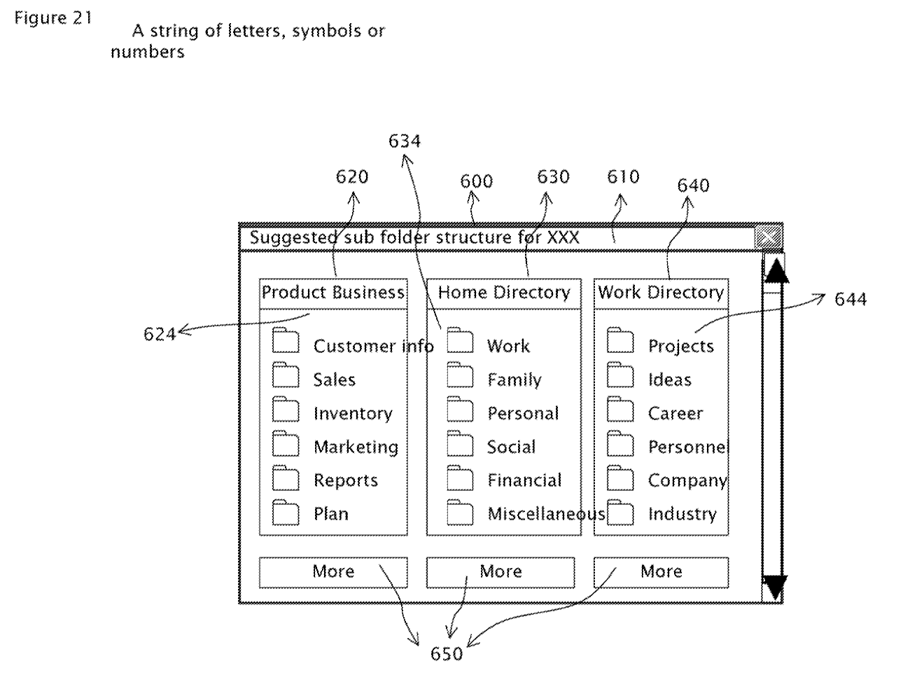

Sometime, a PC user may find that the old directory have too many files and not filed according to a logic folder structure and would like to reorganize all files in a better organized folder structure. The present invention also provided a utility for file reorganization as shown in FIG. 20. This screen is opened by making selection in “Tools” on the Menu Bar. On the left hand side is pan for the Current Directory 140 and right side is the pan for New Directory 142a in which the folders can be designed according to the user. To further assist making a good folder and sub folder structure, a set of suggested folder and subfolders structures are provided in a box 600 as shown in FIG. 21, which can be activated by, for example, the right click function. It is natural that further elements can be added to this box to make it more useful.

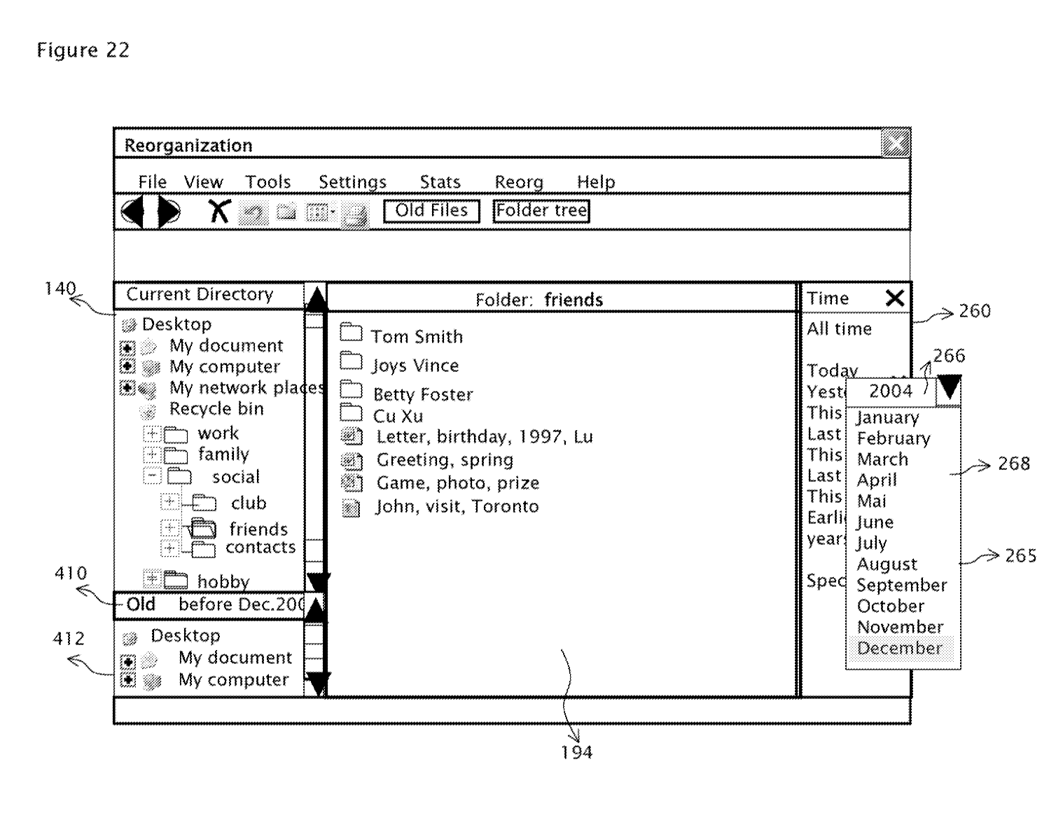

One way to help reduce the clogging of the directory system is to store the old and less used files in separate directory. The screen for this function can be designed in the way as shown in FIG. 22, which can be activated by clicking the “Old Files” button the tool bar. The time before which all the files are stored can be specified by the user.

This can greatly reduce the amount of files that the user has to go through when looking for a file in the directory system. In this way, the user only deals with the current files within a user defined period of time, for example, the last 12 months. The particular time defining Old Files can be revised as time goes by either automatically or manually. One can also remove the storage and combine all files in the current directory system by elect a function in “Tools” or in “Settings”.

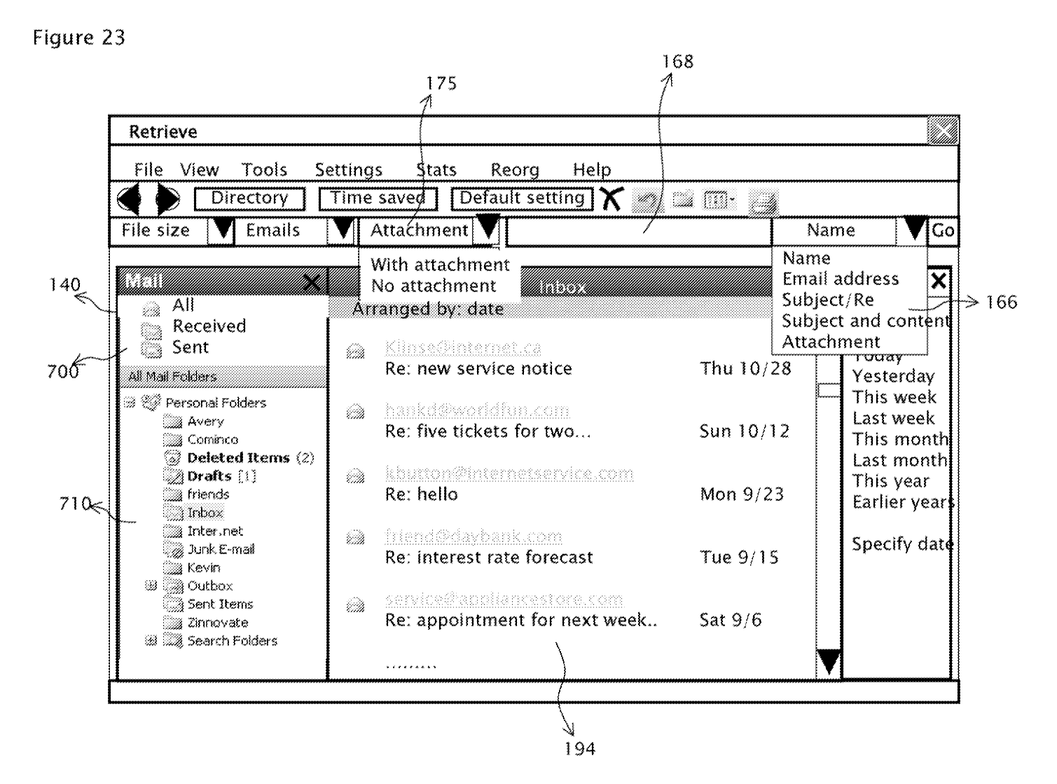

Emails are special types of files, which are typically organized and retrieved by an independent Interface system. The current file management and interface system can be adapted to include the attributes particular for emails and thus used for retrieve emails, FIG. 23 illustrates a screen design for retrieving emails, which has functions for helping the user to better retrieve emails. More specifically, whether the mail is “sent” or “received” can be used as aid. As well, email address, subject, name of the sender or receiver and content can be used for matching emails. Further, whether an email has an attachment in a box 175 can be used to refine the retrieval.

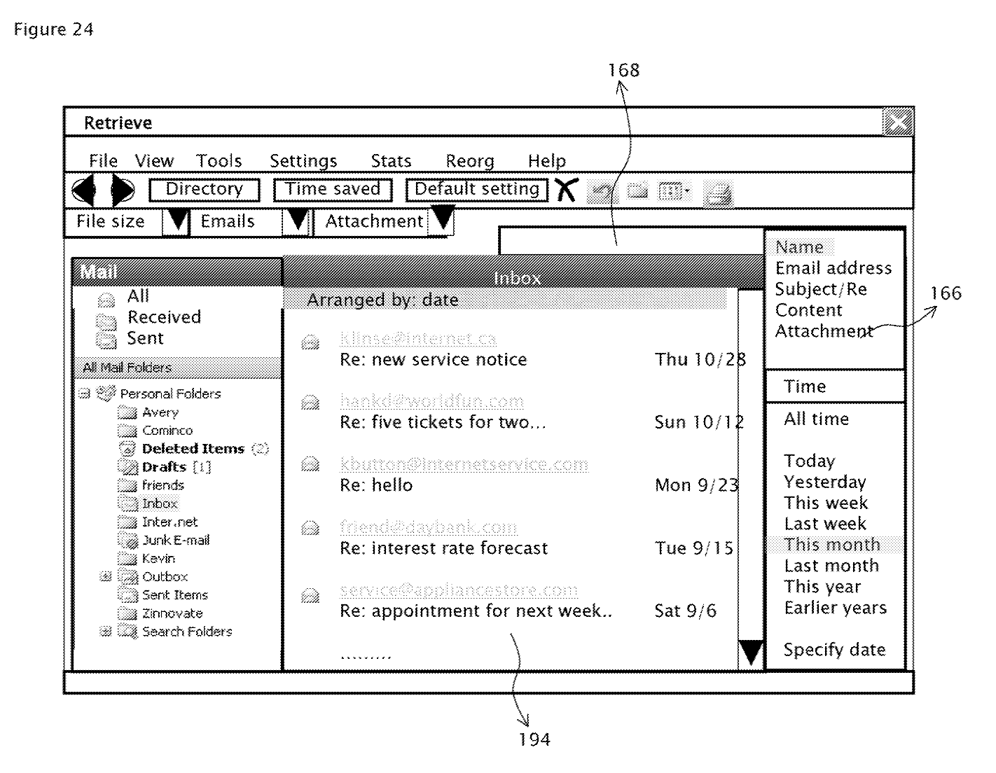

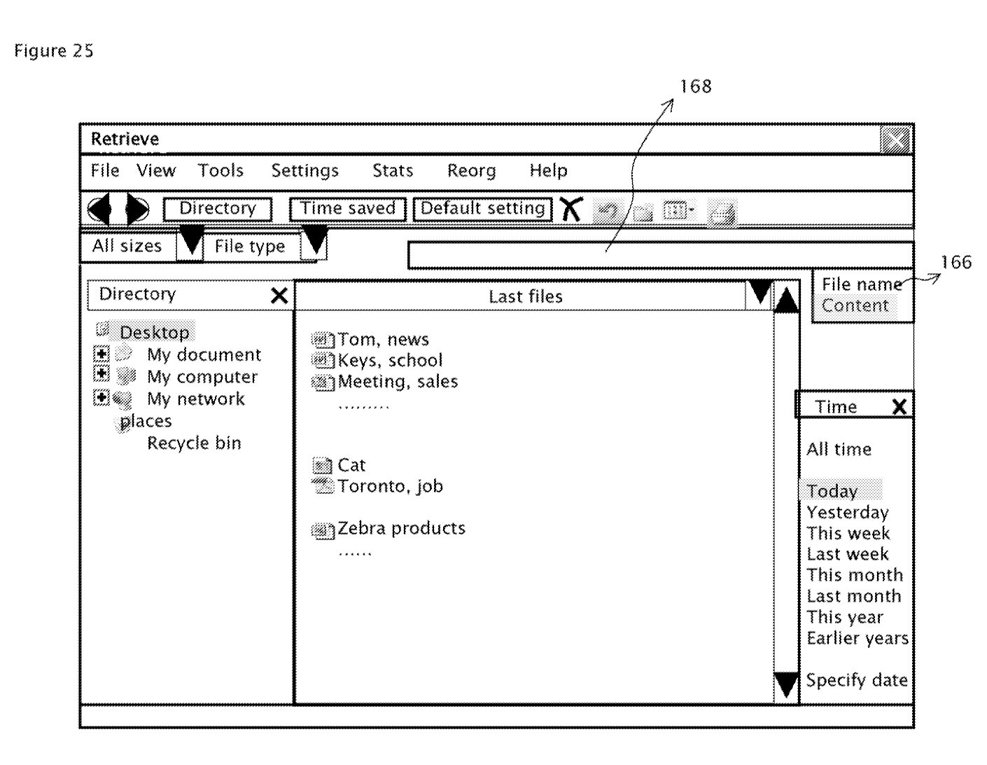

The keyword search may further be streamlined by making the scope selections 166 for keywords match fully displayed and by removing the full down menu 169 and Go button 162 as illustrated in FIG. 24 for retrieving emails. In operation, after typing key words in keywords box 168 and clicking one item in the scope selections that will highlight the item, the matching process will start. Similar modification on the operation of keyword matching can be done for file retrieval as shown in FIG. 25. This provides all scope selections for keywords match visually apparent to the user all the time and allow the user to combine the actions of scope selection and activation of matching process.

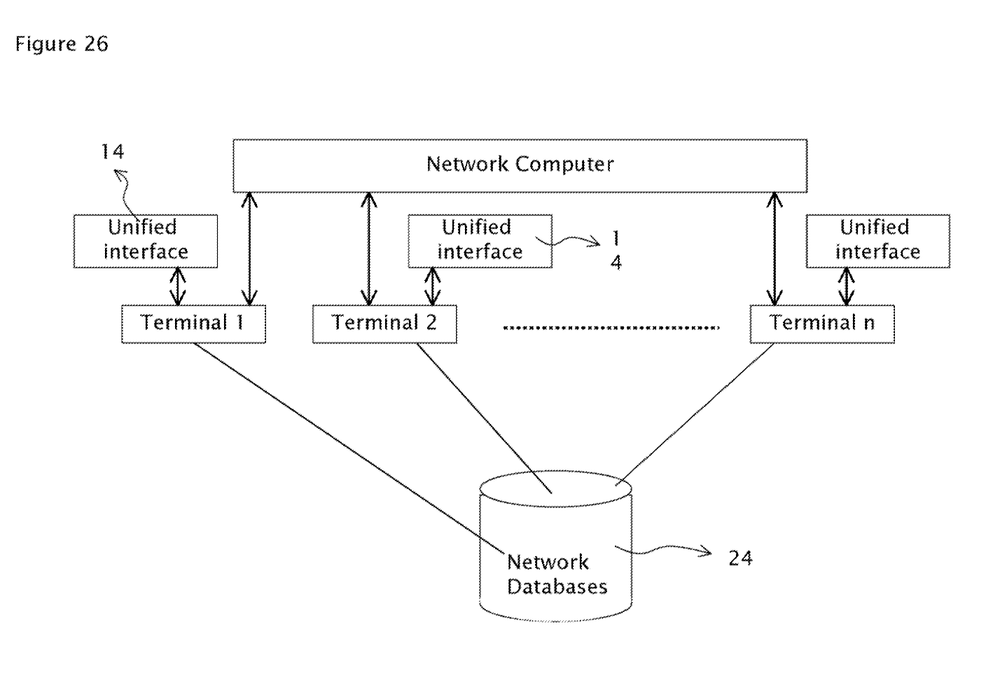

Also, as illustrated in FIG. 26, the present invention can be implemented in a multiple-user network environment, in a manner that is well known. Such an implementation may require the definition of specific rules to manage files in the network environment in accordance with the present invention. For example, a particular file in a specific drive would be defined as being either read-only or change-permitted. Where several people would work on the same file from different Terminal locations (the terminals either being personal computers connected to a network or network computers), the file could be replaced by the most recent version or be saved as a different file with an extra identifier defined by the particular terminal automatically, or defined by the user by means of selection of a keyword, as provided above. These and other accommodations required to implement the present invention in a network environment are well known to those skilled in the art.

Other variations and modifications of the invention are possible. In particular, it should be understood that the graphic design for all the screens illustrated are only for examples and each and every icons and buttons or items on the tool bars can be designed in variety of ways without altering the spirit of the present invention. All such modifications or variations are believed to be within the spirit and scope of the invention as defined by the claims appended hereto.

I claim:

1. A user interface system for retrieving files, comprising:
(a) a database for storing file attributes including subject, keywords, information related to time, location in file directory system, file size, file type, indexing data, textual data and graphic data,
(b) a file sorting facility for identifying, creating, and organizing data related to file attributes in the database,
(c) a search engine
(d) a digital data display screen and
(e) an operation program for realizing and coordinating the functions of database, sorting facility, search engine and display screen.

2. The user interface system in claim 1, wherein the digital data display screen further comprises a plurality of data display fields that are selected from the group comprising:
(a) a directory tree field;
(b) a time selection field;
(c) a file size selection field;
(d) a file type selection;
(e) a file list display field;
(f) a keywords data field; and
(g) a menu bar.

3. The user interface system in claim 2, wherein the file list display field dynamically updates the list of files according to the conditions specified in the directory field, time selection field, file type selection field, file size field and keywords data field.

4. The user interface system in claim 2, wherein the file list display field has a file list menu selector for specifying the order of listed files by alphabetical manner, or chronological manner, or historical manner, or file type, or file size, or relationship in directory tree, or degree of relevance related to textual or graphic content in the files.

5. The user interface system in claim 2, wherein the menu bar comprises a plurality of menu categories of operation commands.

6. The user interface system in claim 2, wherein it further comprises a tool bar with iconic items for the commands selected from the menu categories in the menu bar.

7. The user interface system in claim 2, wherein the system has a default setting facility on the menu bar for specifying the default conditions in the plurality of data display fields.

8. The user interface system in claim 2, wherein the time selection field comprises plurality of time periods specified in the default settings facility.

9. The user interface system in claim 2, wherein individual file listed in the file list display field displays a pop-up of textural data or graphic data of the file when the curser is near the file name.

10. A method for visually orientated file retrieval comprising:
(a) a database for storing file attributes including subject, keywords, information related to time, location in file directory system, file size, file type, indexing data, textual data and graphic data,
(b) a file sorting facility for identifying, creating, and organizing data related to file attributes in the database,
(c) a search engine,
(d) a digital data display screen, and
(e) an operation program for realizing and coordinating the functions of database, sorting facility, search engine and display screen.

11. The method for visually oriented file retrieval in claim 10, wherein the retrieving operation comprising the functions of:
(a) persistently displaying a file list display field;
(b) displaying a selectable directory tree field;
(c) displaying a selectable time selection field;
(d) displaying a selectable file size selection field;
(e) displaying a selectable file type selection field;
(f) displaying a selectable keywords data field;
(g) displaying a menu bar of operation commands; and
(h) dynamically updating the file list display field as the conditions in each of the other fields are updated.

12. The method for visually oriented file retrieval in claim 11, wherein the file list display field dynamically updates the list of files according to the conditions specified in the directory field, time selection field, file type selection field, file size field and keywords data field.

13. The method for visually oriented file retrieval in claim 11, wherein the file list display field has a file list menu selector for specifying the order of listed files by or alphabetical manner, or chronological manner, or historical manner, or file type, or file size, or relationship in directory tree, or degree of relevance related to textual or graphic content in the files.

14. The method for visually oriented file retrieval in claim 11, wherein the menu bar comprises a plurality of menu categories for selection of operation commands.

15. The method for visually oriented file retrieval in claim 1, wherein it further comprises a tool bar with iconic items for specific commands selected from the menu bar.

16. The method for visually oriented file retrieval in claim 11, wherein the menu bar has a default setting facility for specifying the default conditions of the plurality of data display fields.

17. The method for visually oriented file retrieval in claim 11, wherein the time selection field comprises plurality of time periods that are specified in the default settings.

18. The method for visually oriented file retrieval in claim 11, wherein individual file listed in the file list field displays a pop-up of textural data or graphic data of the file when the curser is near it.

19. The method for visually oriented file retrieval in claim 10, wherein the method may be applied as a utility module within other software applications or as an independent software application.

20. The method for visually oriented file retrieval in claim 10, wherein the method may be applied in individual personal computers or in a network of plurality of personal computers, servers and mainframes.

21. A software product for visually orientated file retrieval comprising:
(a) a database for storing file attributes including subject, keywords, information related to time, location in file directory system, file size, file type, indexing data, textual data and graphic data,
(b) a file sorting facility for identifying, creating, and organizing data related to file attributes in the database,
(c) a search engine,
(d) a digital data display screen, and
(e) an operation program for realizing and coordinating the functions of database, sorting facility, search engine and display screen.

22. The software product in claim 21, wherein the digital data display screen further comprises, a plurality of data area display fields that are selected from the group comprising:
(a) a directory tree field;
(b) a time selection field;
(c) a file size selection field;
(d) a file type selection;
(e) a file list display field;
(f) a keywords data field; and
(g) a menu bar.
